(19) United States
(12) Patent Application Publication
(10) Pub. No.: US 2008/0141501 A1
(43) Pub. Date: Jun. 19, 2008

(54) Clip

(75) Inventor: Takeshi Kuroda, Kanagawa (JP)

Correspondence Address: Sean M. McGinn;McGinn Intellectual Property Law Group, PLLC, Suite 200, 8321 Old Courthouse Road, Vienna, VA, 22182-3817, US

(73) Assignee: PIOLAX INC., Kanagawa (JP)

(21) Appl. No.: 11/892,489

(22) Filed: Aug. 23, 2007

(30) Foreign Application Priority Data
Aug. 24, 2006 (JP) P2006-227331

(51) Int. Cl. F16B 5/12

(52) U.S. Cl. 24/297

(57) ABSTRACT

A clip includes: a head portion; and a leg portion including: a pair of first engagement arms that are provided on a pair of facing side surfaces of the leg portion; a pair of second engagement arms that are provided on the other pair of facing side surfaces of the leg portion, the pair of second engagement arms including abutment portions adapted to be individually brought into abutment with circumferential edges of respective diametrically extended hole portions of a trim and a panel; a pair of first stopper walls for holding a hole edge of the mounting hole of the panel in cooperation with the respective first engagement arms; and a pair of second stop walls for holding the circumferential edges of the diametrically extended hole portions of the panel in cooperation with the abutment portions of the respective second engagement arms.

### BACKGROUND OF THE INVENTION

1. Field of the Invention

The present invention relates to a synthetic resin clip which is preferably applied, for example, to a sun visor holder for holding a shaft portion of an automotive sun visor.

2. Description of the Related Art

Although not shown specifically, a conventional sun visor holder is made up of two components such as a holder member and a grommet member which are separately molded from a synthetic resin. The former holder member includes a C-shaped holding portion and a cylindrical leg portion, and a pair of engagement pawls are formed on facing side surfaces of the cylindrical leg portion in such a manner as to be deflected. On the other hand, the latter grommet member is molded substantially into a hollow rectangular parallelepiped shape as a whole, and a pair of support pieces for supporting a roof trim are formed on a pair of facing side surfaces, while a pair of open windows from which the respective engagement pawls are allowed to project outwards are defined in the other pair of facing side surfaces, as disclosed in Japanese Patent No. 3628945.

Then, when actually holding a shaft portion a sun visor, firstly, the leg portion of the holder member is pushed into the hollow interior of the grommet member, so that the respective engagement pawls of the holder member project outwards from the corresponding open windows of the grommet member, and thereafter, when the grommet member, which is now integrated with the holder member, is inserted into a mounting hole which is opened in advance in the roof trim, the respective support pieces pass through the mounting hole while being deflected inwards, so as to elastically support a circumferential surface of the mounting hole in the roof trim, whereby the sun visor holder is temporarily secured to the roof trim side.

Then, with the sun visor holder held in such a state, this time, when the grommet member is inserted into a mounting hole which is opened in advance in a roof panel, the engagement pawls of the holder portion which project outwards from the respective open windows of the grommet member are brought into engagement with a hole edge of the mounting hole of the roof panel, whereby the sun visor holder is then properly fixed to the roof panel side. Consequently, thereafter, when the shaft portion of the sun visor is fitted elastically in the C-shaped holding portion of the sun visor holder, the relevant shaft portion is detachably held therein.

On the contrary, when removing the sun visor holder from the roof panel, with the holder member forcibly rotated relative to the grommet member, the pair of engagement pawls of the holder member which project outwards from the open windows enter the interior of the grommet member, so as to release the engagement of the engagement pawls with the hole edge of the mounting hole of the roof panel, whereby when the sun visor holder is pulled out together with the roof trim in this state, the sun visor holder can be removed from the roof panel.

### SUMMARY OF THE INVENTION

Consequently, although the conventional sun visor holder is advantageous not only in that the shaft portion of the sun visor can securely be held but also in that the sun visor holder can easily be removed from the roof panel without using any tool, to make this happen, since the two components such as the holder member and the grommet member are necessary, it cannot be denied that the production costs including costs for molding dies are naturally increased. In addition to this, with the sun visor holder properly fixed to the roof panel, since the respective engagement pawls of the holder member are in engagement with the hole edge of the mounting hole in only the two locations, there has been a sufficient fear that the strong and rigid fixing state of the roof trim cannot be attained.

The invention has been developed with a view to solving effectively the problem inherent in the conventional sun visor holder, and according to a first aspect of the invention, there is provided a clip that is made from a synthetic resin and fixes a trim, in which a mounting hole having a pair of diametrically extended hole portions is opened, to a panel, in which a mounting hole having a pair of diametrically extended hole portions is opened, the clip including: a head portion; and a leg portion that is continuously provided with the head portion, the leg portion including: a pair of first engagement arms that are deflectably provided on a pair of facing side surfaces of the leg portion; a pair of second engagement arms that are deflectably provided on the other pair of facing side surfaces of the leg portion, the pair of second engagement arms including abutment portions adapted to be individually brought into abutment with circumferential edges of the respective diametrically extended hole portions of the trim and the panel; a pair of first stopper walls that are provided on the pair of facing side surfaces of the leg portion, the pair of first stopper walls holding a hole edge of the mounting hole of the panel in cooperation with the respective first engagement arms; and a pair of second stop walls that are provided on the other pair of facing side surfaces, the pair of second stop walls holding the circumferential edges of the diametrically extended hole portions of the panel in cooperation with the abutment portions of the respective second engagement arms.

According to a second aspect of the invention, the clip according to the first aspect of the invention, further including slits that are provided in distal end portions of the pair of second engagement arms, the slits admitting the pair of corresponding second stopper walls thereto in an engaging fashion, at least when mounted on to the panel.

Consequently, according to the first aspect of the invention, since the clip itself is the integrally molded component from the synthetic resin, needless to say, the production costs including the costs for molding dies become low. In addition, when fixing the trim to the panel, in the event that the leg portion is inserted into the mounting hole in the trim while the pair of second engagement arms are made to face the interiors of the diametrically extended hole portions possessed by the mounting hole on the trim side, the trim is supported by the head portion and the abutment portions of the second engagement arms, whereby the clip itself is temporarily secured to the trim side. Then, in this state, in the event that the leg portion is inserted into the mounting hole in the panel while the pair of the second engagement arms are similarly made to face the interiors of the diametrically extended hole portions possessed by the mounting hole on the panel side, this time, the abutment portions of the pair of second engagement arms hold the circumferential edges of the diametrically extended hole portions of the panel in cooperation with the second stopper walls at the same time that the pair of first engagement arms pass through the mounting hole to hold the hole edge of the mounting hole of the panel in cooperation with the first stopper walls, whereby the trim is properly fixed to the panel. Thus, with the clip mounted on the panel in this way, since the clip is mounted on the panel in four locations by the pair of first engagement arms and the pair of second engagement arms, the fixing state of the trim becomes stable and strong remarkably.

According to the second aspect of the invention, as a result of providing the slits in the distal end portion of the pair of second engagement arms so as to admit the second stopper walls thereto in the engaging fashion, at least, when mounted on to the panel, the rigidity of the pair of second engagement arms which reside in the diametrically extended hole portions of the panel is increased, whereby an unnecessary looseness of the clip itself within the mounting holes in the trim and the panel can be effectively prevented, and in the event that the clip is rotated for removal, even when the pair of second engagement arms are forced to be deflected inwards of the mounting hole of the panel for entrance thereto, since the second stopper walls also enter the slits in the engaging fashion to increase the rigidity, the deformation of the second engagement arms in the rotating direction can be suppressed effectively, so as to prevent the failure thereof effectively.

### BRIEF DESCRIPTION OF THE DRAWINGS

These and other objects and advantages of this invention will become more fully apparent from the following detailed description taken with the accompanying drawings in which:

FIG. 1 is a perspective view showing a state in which a clip according to an embodiment of the invention is applied as a sun visor holder;

FIG. 2A is a front view of the clip;

FIG. 2B is a side view of the same clip;

FIG. 3A is a sectional view taken along the line A-A in FIG. 2A;

FIG. 3B is a sectional view taken along the line B-B in FIG. 2B;

FIG. 3C is a sectional view taken along the line C-C in FIG. 2B;

FIG. 4 is a main part explanatory drawing which illustrates configurations of respective mounting holes in a roof trim and a roof panel;

FIG. 5A is a main part sectional view showing a state in which the clip is temporarily secured to the roof trim side;

FIG. 5B is a plan view showing the same state;

FIG. 6A is a main part sectional view showing a state in which the clip is temporarily secured to the roof panel side;

FIG. 6B is a plan view showing the same state;

FIG. 7A is a main part sectional view showing a state in which the clip is rotated through 90° within the mounting hole in the roof panel;

FIG. 7B is a plan view showing the same state; and

FIG. 8 is a main part sectional view showing a state in which the clip is removed from the roof panel.

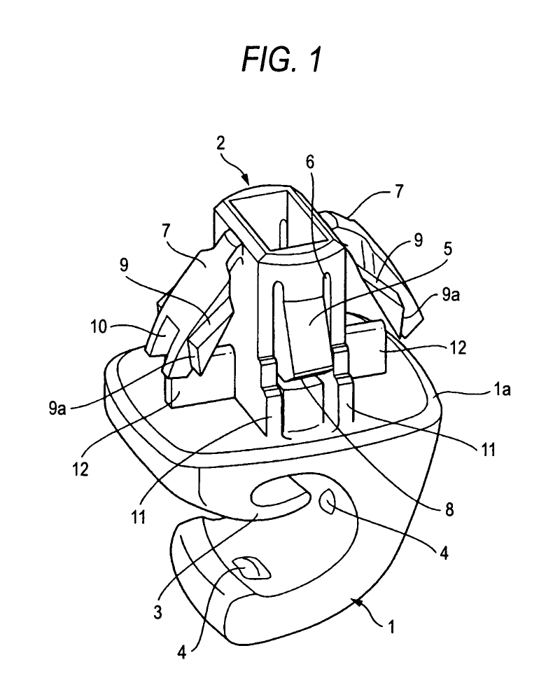

### DETAILED DESCRIPTION OF THE EMBODIMENTS

The invention is made to fix a trim to a panel strongly with a clip while maintaining the production cost thereof low, based on an assumption that there is provided a clip made from a synthetic resin for fixing a trim in which a mounting hole having a pair of diametrically extended hole portions is opened to a panel in which a mounting hole having a pair of diametrically extended hole portions is opened, in which a leg portion which is formed to be continuously integral with a head portion is made to include a pair of first engagement arms which are provided on a pair of facing side surfaces thereof in such a manner as to be deflected, a pair of second engagement arms which are provided on the other pair of facing side surfaces thereof in such a manner as to be deflected and which has abutment portions adapted to be individually brought into abutment with circumferential edges of the respective diametrically extended hole portions of the trim and the panel, a pair of first stopper walls which are provided on the pair of facing side surfaces thereof for holding a hole edge of the mounting hole of the panel in cooperation with the respective first engagement arms, and a pair of second stop walls which are provided on the other pair of facing side surfaces for holding the circumferential edges of the diametrically extended hole portions of the panel in cooperation with the abutment portions of the respective second engagement arms.

Hereinafter, to describe the invention in detail based on a preferred embodiment illustrated in the accompanying drawings, a clip according to the embodiment is such as to be developed as a sun visor holder for holding a shaft portion of an automotive sun visor, and the clip is molded integrally from a synthetic resin and is specifically constructed so as to be made up of a C-shaped holding portion 1 which makes up a head portion and an angularly cylindrical leg portion 2.

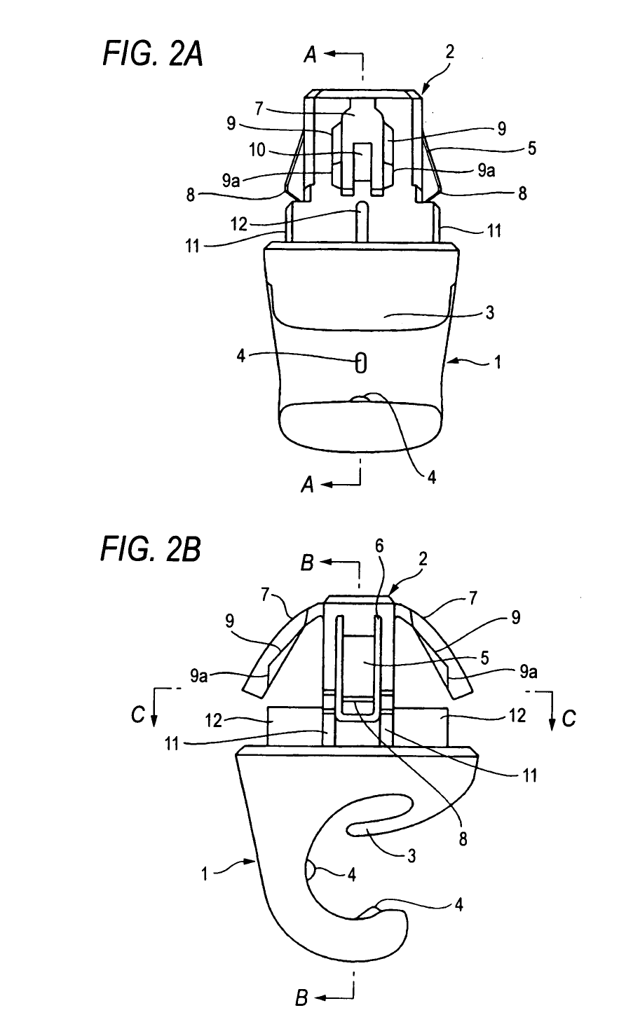

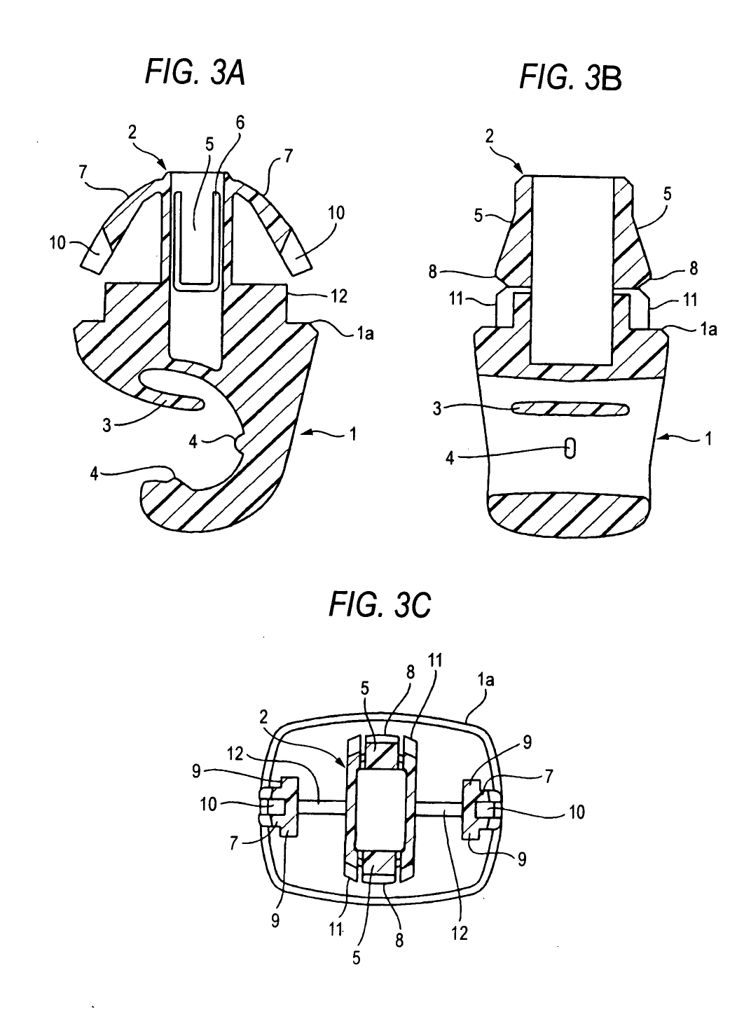

In addition, the former holding portion 1 is, as is also shown in FIGS. 2A to 3C, such as to hold elastically the shaft portion of the sun visor in its C-shaped interior, and is configured such that a spring piece 3 and a plurality of projections 4 are formed integrally on an inner surface side of the C-shaped interior, so that the shaft portion is detachably held in the C-shaped interior by pressing the shaft portion of the sun visor towards the respective projections 4 by means of the spring piece 3, whereby the abrupt dislocation of the shaft portion from the C-shaped interior is prevented while in a normal use.

Similarly, as is also shown in FIGS. 2A to 3C, the latter leg portion 2 is configured such that a pair of first engagement arms 5, which extend from a distal end of the leg portion 2 towards the holding portion 1, are provided on a pair of facing side surfaces which partly make up an angularly cylindrical shape in such a manner as to be deflected via cuts 6, a pair of second engagement arms 7, which extend from the distal end of the leg portion 2 towards the holding portion 1 while expanding, are provided on the other pair of facing side surfaces in such a manner as to be deflected, engagement shoulder portions 8 are integrally formed, respectively, on free end edges of the first engagement arms 5 in such a manner as to be brought into engagement with a hole edge of a mounting hole 24 in a roof panel 23, which will be described later, and two abutment portions 9 are integrally formed, respectively, on both side edges of the second engagement arms 7 in such a manner as to be brought individually into abutment with circumferential edges of diametrically extended hole portions 22a, 24a possessed by respective mounting holes 22, 24 in a roof trim 21, which will be described later, and the roof panel 23.

In addition, a configuration is also adopted in which slits 10 are opened in central positions on distal end portions of the pair of second engagement arms 7 for admitting second stopper walls 12, which will be described later, thereto in an engaging fashion, at least, when the clip is mounted on the roof panel 23. In addition, a tapered configuration is positively given to a lower surface 9a side of each of the abutment portions 9 in consideration of a case where the thickness of the roof trim 21 only is dealt with and a case where the thicknesses of both the roof trim 21 and the roof panel 23 are dealt with.

Furthermore, in this embodiment, a pair of first stopper walls 11, which exhibits a bifurcate shape for holding the hole edge of the mounting hole 24 in the roof panel 23 in cooperation with the respective first engagement arms 5, are provided, respectively, on the pair of facing side surfaces in such a manner as to project therefrom, and the pair of second stop walls 12, which are each made up of a single wall for holding the circumferential edges of the diametrically extended hole portions 24a in the roof panel 23 in cooperation with the abutment portions 9 of the respective second engagement arms 7, are provided on the other pair of facing side surfaces in such a manner as to project therefrom, so that when the clip is mounted on the roof panel 23, the hole edge of the mounting hole 24 and the circumferential edges of the diametrically extended hole portions 24a can be held strongly in four locations.

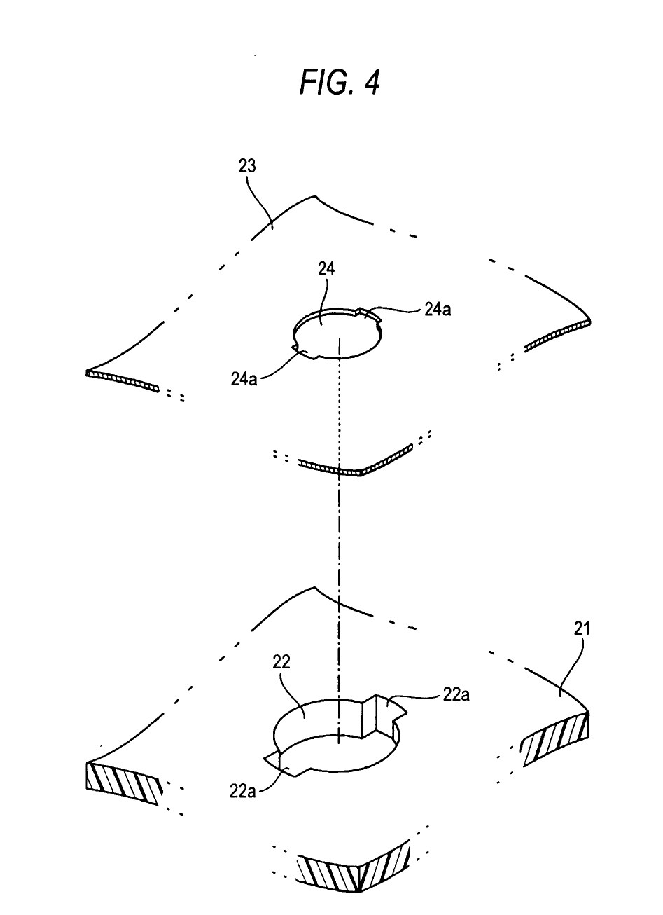

In addition, as is shown in FIG. 4, the mounting hole 22 opened in the roof trim 21 is formed as a completely regular circle, and a pair of diametrically extended hole portions 22a into which the second engagement arms 7 are to be inserted respectively are formed on facing circumferential edge sides thereof. Similarly, as is also shown in the same figure, the mounting hole 24 which is opened in the roof panel 23 is formed as a completely regular circle, and the pair of diametrically extended hole portions 24a into which the second engagement arms 7 are to be inserted respectively are formed on facing circumferential edges thereof.

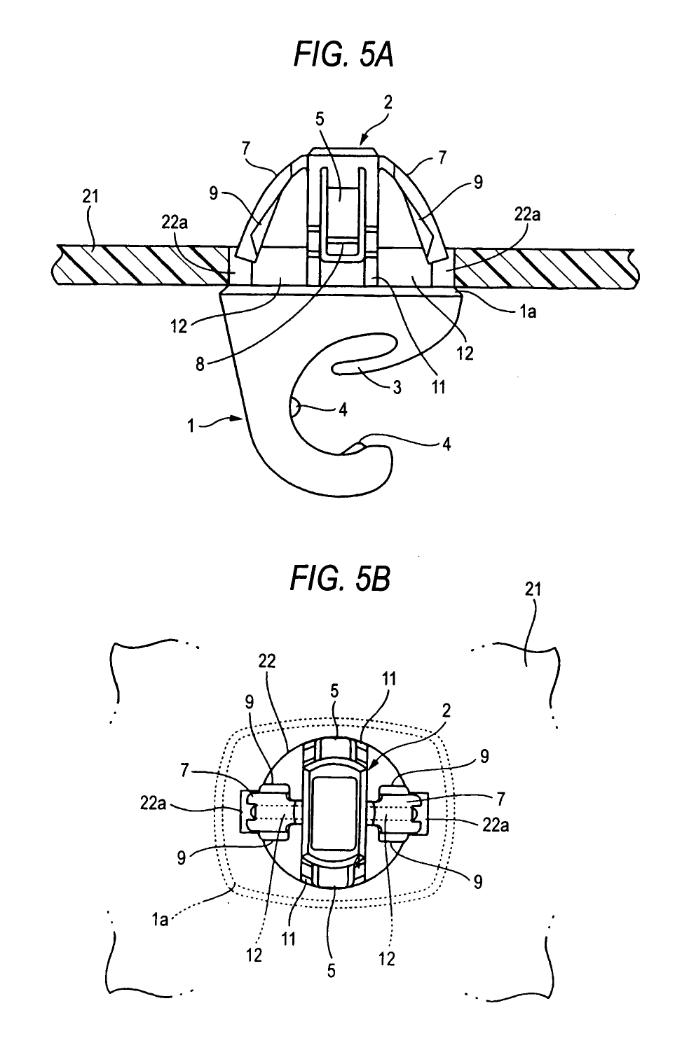

Consequently, when the clip is used to hold the shaft portion of the sun visor with the holding portion 1 thereof, firstly, the relevant clip is temporarily secured to the roof trim 21. As this occurs, when the leg portion 2 is inserted into the mounting hole 22 from a distal end side thereof with the second engagement arms 7 made to face the respective diametrically extended hole portions 22a of the mounting hole 22 in the roof trim 21, as is shown in FIGS. 5A and 5B, the pair of engagement arms 7 are inserted into the mounting hole 22 while being deflected inwards, and the abutment portions 9 of the respective second engagement arms 7 and the respective first engagement arms 5 are made to pass through the mounting hole 22. Note that in this state, a maximum dimension between the pair of first engagement arms 5 is set to be smaller than an inside diameter of the mounting hole 22 in the roof trim 21.

In addition, in this state, since the roof trim 21 comes to be supported from the inside and outside thereof by an enlarged circumferential edge of the holding portion 1 to which a chamfered portion 1a is provided and the tapered lower surfaces 9a of the four abutment portions 9, the secure and stable temporary fixing state of the clip relative to the roof trim 21 is ensured. In addition, also as this occurs, in the event that upper end portions of the second stopper walls 12 are configured to enter the corresponding slits 10 which are opened in the distal end portions of the pair of second engagement arms 7 in the engaging fashion, the rigidity of the pair of engagement arms 7 is increased so as to prevent the deformation thereof, whereby unnecessary looseness and rotations are prevented, and in this respect, too, the temporary securing state of the clip is ensured and stabilized further. In this case, the pair of first engagement arms 5 are not involved at all in the temporary securing of the clip.

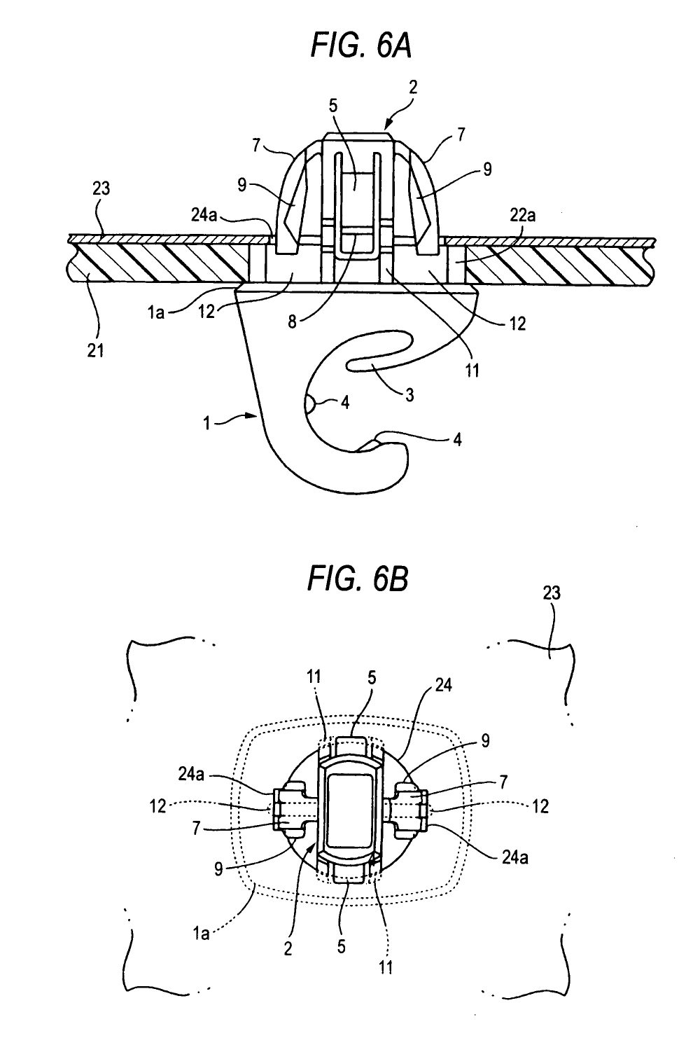

Then, this time, the clip, which is being temporarily secured to the roof trim side 21, is inserted into the mounting hole 24 in the roof panel 23. As this occurs, too, when the leg portion 2 is inserted into the mounting hole 24 from the distal end side thereof with the second engagement arms 7 made to face the respective diametrically extended hole portions 24a of the mounting hole 24 in the roof panel 23, as is shown in FIGS. 6A and 6B, the pair of first engagement arms 5 pass through the mounting hole 24 while being deflected inwards at the hole edge of the mounting hole 24 in the roof panel 23, and after the passage of the mounting hole 24, the respective engagement shoulder portions 8 which are formed on the free end sides of the respective first engagement arms 5 are automatically brought into engagement with the hole edge of the mounting hole 24, whereby the hole edge of the mounting hole 24 is held from the inside and outside thereof by the pair of first engagement arms 5 and the pair of first stopper walls 11.

Furthermore, in addition to this, the tapered lower surfaces 9a of the respective abutment portions 9 of the pair of second engagement arms 7 are brought into abutment with circumferential edges of the respective diametrically extended hole portions 24a possessed by the mounting hole 24 in the roof panel 23, whereby the circumferential edges of the diametrically extended hole portions 24a of the relevant mounting hole 24 are held from the inside and outside thereof by the abutment portions 9 of the pair of second engagement arms 7 and the pair of second stopper walls 12. Consequently, by this configuration, the roof trim 21 is eventually properly fixed to the roof panel 23. In this mounting state of the clip on the roof panel 23, since the clip is mounted on the roof panel 23 in four locations by the pair of first engagement arms 5 and the pair of second engagement arms 7, when compared with the conventional clip, the fixing state of the trim becomes strong remarkably.

In addition, in such a state, since the upper end portions of the second stopper walls 12 are allowed to enter the corresponding slits 10 which are opened in the distal end portions of the pair of second engagement arms 7 in the engaging fashion, whereby the rigidity of the second engagement arms 7 which face the interiors of the respective diametrically extended hole portions 24a of the mounting hole 24 in the roof panel 23 is increased, thereby making it possible to prevent the occurrence of unnecessary looseness of the clip itself within the mounting holes 22, 24 of the roof trim 21 and the roof panel 23. Consequently, although not specifically illustrated, after this, when the shaft portion of the sun visor is elastically fitted in the holding portion 1 of the clip which is mounted on the roof panel 23 side, the relevant shaft portion is detachably held therein.

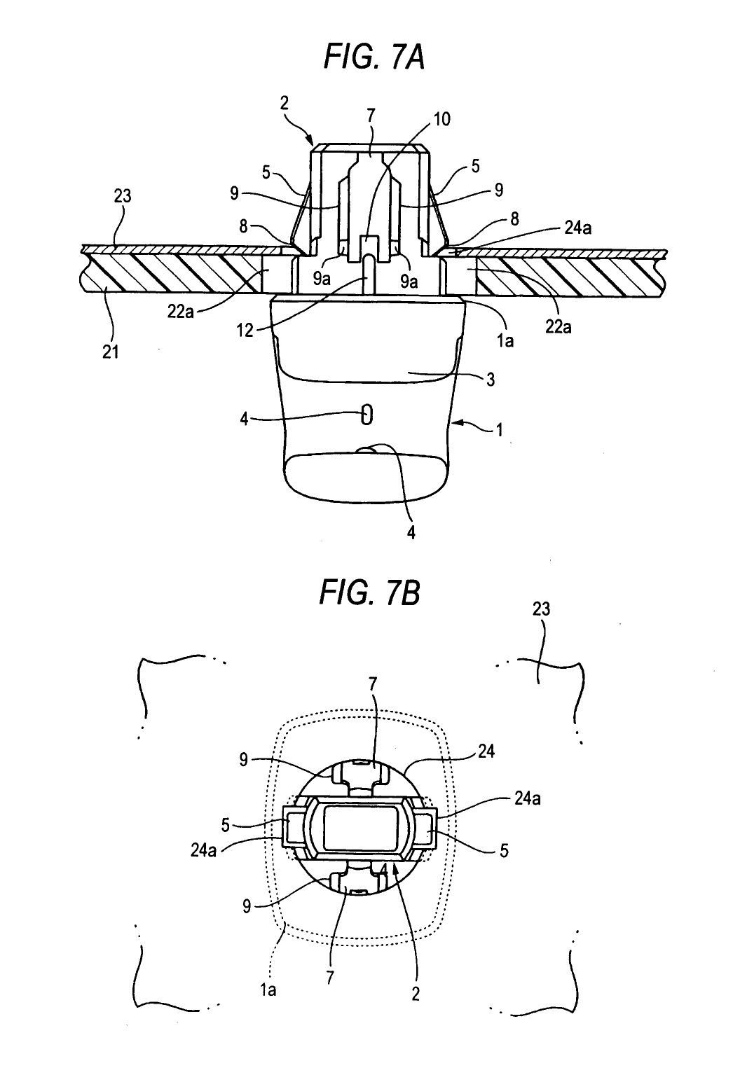

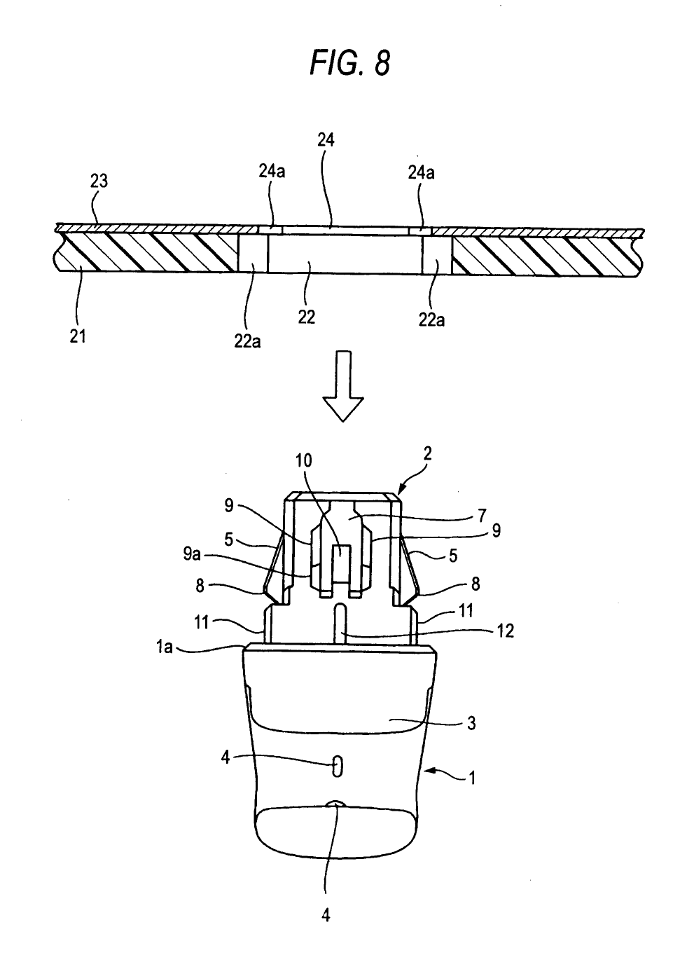

On the contrary, when the clip is removed from the roof panel 23, when the clip is rotated through 90° by pinching the clip itself at the holding portion 1 or the like, so that the pair of second engagement arms 7 which faces the interiors of the diametrically extended hole portions 24a possessed by the mounting hole 24 of the roof panel 23 are made to enter the mounting hole 24 while causing them to be deflected inwards of the same hole, then, this time, as is shown in FIGS. 7A and 7B, the pair of first engagement arms 5 are made to face the interiors of the respective diametrically extended hole portions 24a of the relevant mounting hole 24. After such a state has been obtained, as is shown in FIG. 8, the pair of first engagement arms 5 are pulled backwards to be allowed to pass through the respective diametrically extended hole portions 24a possessed by the mounting hole 22 of the roof trim 21 by pulling out the clip only. Consequently, by this configuration, the clip can be removed easily and simply from the roof panel 23, and at the same time as this occurs, the fixing state of the roof trim 21 is released on the spot, whereby the clip can also easily be removed from the roof trim 21.

In addition, in removing the clip in this way, also when the pair of second engagement arms 7 are forcibly deflected inwards to enter the mounting hole 24 in the roof panel 23, as has been described above, since the second stopper walls 12 enter, in the engaging fashion, the interiors of the slits 10 opened in the pair of second engagement arms 7 so as to increase the rigidity of the relevant engagement arms, the deformation of the respective second engagement arms 7 in the rotating direction can be suppressed effectively, thereby making it possible to prevent the failure thereof effectively.

In the embodiment that has been described heretofore, while the clip of the invention is described as being applied to the sun visor holder for holding the shaft portion of the sun visor, the invention is not limited thereto, and hence, by making use of the holding portion 1 as the head portion according to the original design, the clip of the invention can widely be applied to clips for simply fixing other automotive trims to body panels.

Since the clip according the invention is low in cost and can fix the trim to the panel strongly, when the clip is applied to a sun visor holder for holding a shaft portion of an automotive sun visor, a remarkably preferable result will be provided.

What is claimed is:

1. A clip that is made from a synthetic resin and fixes a trim, in which a mounting hole having a pair of diametrically extended hole portions is opened, to a panel, in which amounting hole having a pair of diametrically extended hole portions is opened, the clip comprising:
a head portion; and
a leg portion that is continuously provided with the head portion, the leg portion including:
a pair of first engagement arms that are deflectably provided on a pair of facing side surfaces of the leg portion;
a pair of second engagement arms that are deflectably provided on the other pair of facing side surfaces of the leg portion, the pair of second engagement arms including abutment portions adapted to be individually brought into abutment with circumferential edges of the respective diametrically extended hole portions of the trim and the panel;
a pair of first stopper walls that are provided on the pair of facing side surfaces of the leg portion, the pair of first stopper walls holding a hole edge of the mounting hole of the panel in cooperation with the respective first engagement arms; and
a pair of second stop walls that are provided on the other pair of facing side surfaces, the pair of second stop walls holding the circumferential edges of the diametrically extended hole portions of the panel in cooperation with the abutment portions of the respective second engagement arms.

2. The clip according to claim 1, further comprising slits that are provided in distal end portions of the pair of second engagement arms, the slits admitting the pair of corresponding second stopper walls thereto in an engaging fashion, at least when mounted on to the panel.
